(19) United States
(12) Patent Application Publication
(10) Pub. No.: US 2012/0107777 A1
(43) Pub. Date: May 3, 2012

(54) Methods For Generating Personalized Language Learning Lessons

(76) Inventor: Vladimir Kovin, Jersey City, NJ (US)

(21) Appl. No.: 12/912,850

(22) Filed: Oct. 27, 2010

(51) Int. Cl. G09B 19/06

(52) U.S. Cl. 434/157

(57) ABSTRACT

Novel methods for generating language learning lessons. A learner is allowed to speak out loud a sentence in a foreign language while an instructor types down exactly how the sentence is spoken in a first column on a lesson sheet. The instructor then writes out a correct sentence marked with symbols noting the incorrect word and missing word in a second column parallel to the first column. Unfamiliar word is then placed in a third column and mispronounced word is placed in a fourth column. Words in third column and fourth column is further practiced in homework and in next lesson by using them to make new sentence by the learner.

### DESCRIPTION OF RELATED ART

The present application relates to language learning, and more particularly to methods for generating personalized language learning lessons.

Note that the points discussed below may reflect the hindsight gained from the disclosed inventions, and are not necessarily admitted to be prior art.

Mastering a foreign language besides a native language has been many people's struggle and on the top of many parents' wish lists for their children. Numerous methods and systems have been developed in helping people to achieve this difficult skill.

Multimedia systems such as the one described in the US Patent Application US 2010/0159425 (A1), where a DVD authoring tool arranges a first stream of video clips together with a synchronize audio in a foreign language. A symbolic marker is placed in a subtitle track associated with the first stream. The marker symbolizes upcoming complex word usage, grammar patterns, idiomatic expressions, and colloquialisms in the first stream, and is linked to a second stream of video clips, the second stream of video clips including synchronized audio of an instructional nature regarding the target language of the first stream of video clips. During DVD play, user selects a symbolic marker to pause the first stream and plays the second stream, the first stream resuming upon completion of the second stream.

Another type of language learning tool is as described in US Patent Application US 2010/0159425 (A1), which uses a weighting factor for the learning system that scores a learner's correct answers to an audio data. The weighting factor is updated according to an acoustic model and a language model.

Other computer aided language learning tools, such as the one described in the US Patent Application US 2010/0076943 (A1), uses database of language sentences in comparison with corresponding foreign language sentences. Language structures of individual sentences are analyzed in parallel.

However, none of these methods provide a very satisfactory solution for the very personal nature of language learning. The pre-programmed teachings inherently cannot satisfy all the needs of a learner.

### SUMMARY

The present application discloses new approaches for generating personalized language learning lessons.

In one embodiment, an instruction sheet is used, for lesson one, an instructor types down everything that a language learner says in Column A. After a thought of the learner is finished, the instructor corrects what in Column A using different symbols for incorrect words and phrases and for missing words in Column B. The new words or phrases from Column A and B are put in Column C.

These new words and phrases are subsequently copied to the second lesson on a new instruction sheet, and the learner uses the new words to write sentences in Column A, and the instructor corrects the sentences in Column B during lesson 2. The learner also reads out loud the mispronounced words. If the word were not pronounced correctly, the word continues to be transferred to the next lesson.

In one embodiment, the learner reads material based on his/her interests, and as he/she reads, the instructor types the mispronounced words in Column D. Instructor then adds all the unfamiliar words in Column C.

In one embodiment, the instruction sheet is generated from Google™ document and spreadsheet program that can be shared and saved by learners and instructors remotely. The language lessons are generated remotely.

This interactive process of generating language lessons allows the learners, the instructor to see his/her verbal mistakes, become conscious of these mistakes and thereby control his/her way of using those words in the correct way much more efficiently.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 schematically shows an example instruction sheet in accordance with this application.

FIGS. 2-4 shows screenshots of an example personalized lesson generated using Google™ Document interface.

FIGS. 5, 6 shows a screenshot of an example cheat sheet as reference for students to refer to grammar rules.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the described methods also applies to other language learning; for clarity reason, the examples are given based on learning English by a Russian speaking student, but an ordinary person in the art would know the variations to modify lessons to apply to other languages.

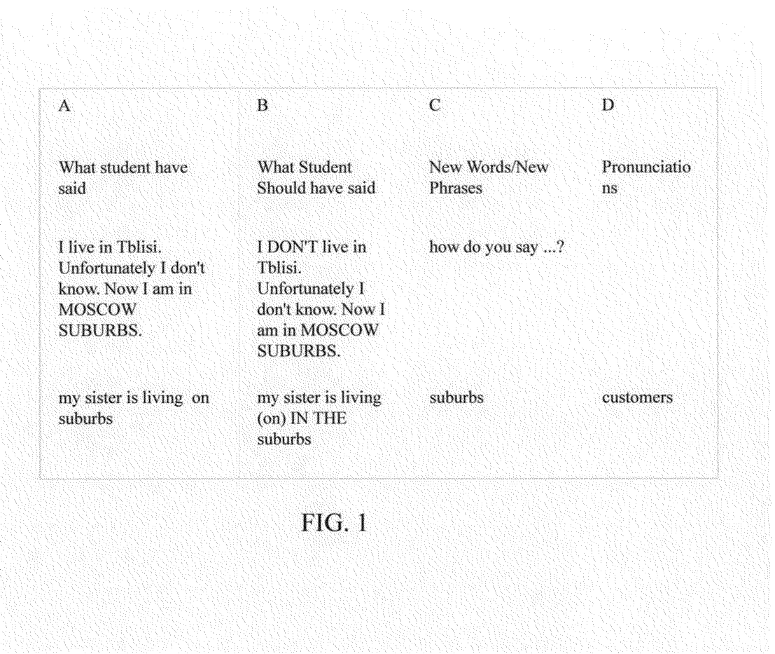

In reference to FIG. 1, it shows a four column instruction sheet for generating language lessons. Column A is for writing/typing down what a student said, Column B is for the instructor to write out the corrections with emphasis by either with color, capital letters or symbols such as parenthesis. Parenthesis may be used to remove the incorrect words or phrases, capital letters to insert what is missing, etc. Column C is used to pick out the new words, and Column D is used to record the mispronounced words. Each row for one thought of the learner.

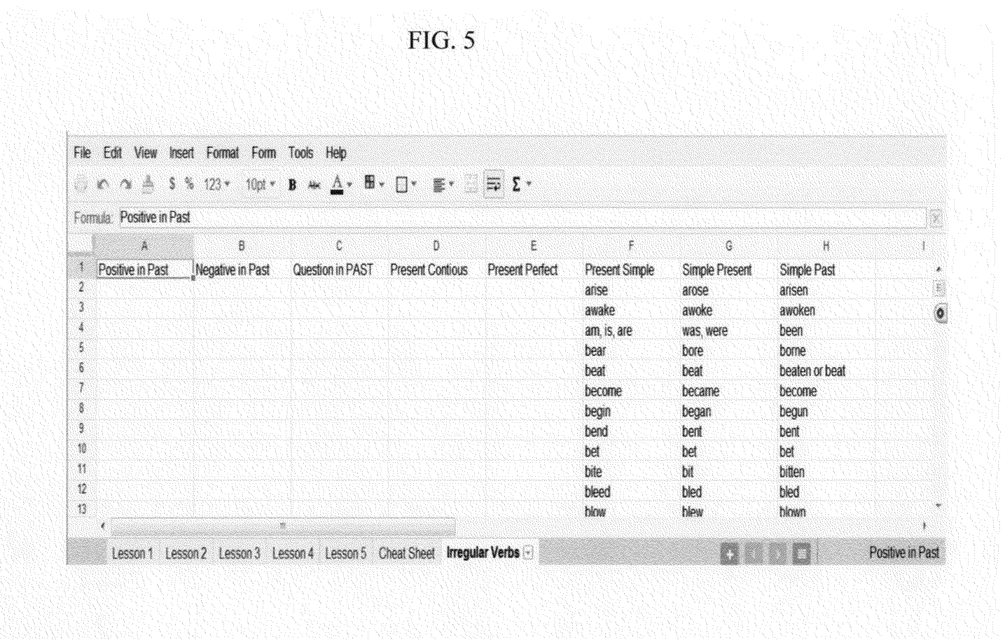

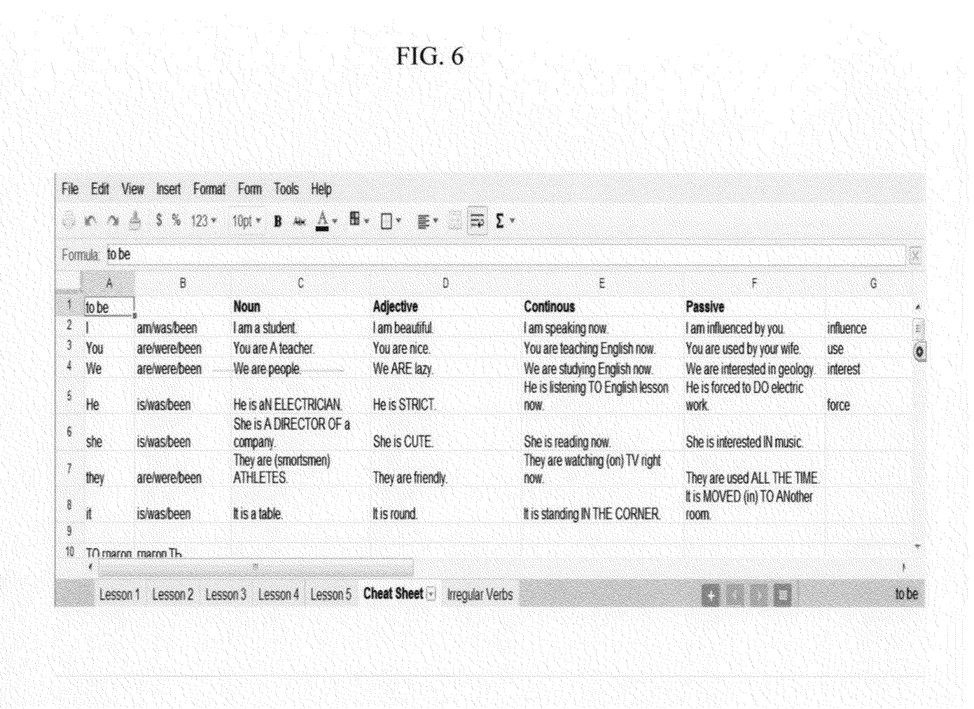

To generate a personalized English lesson, an instructor may first explain a cheat sheet of the irregular verbs and grammar changes in English, as shown in FIGS. 5 and 6, and direct the student to speak only English in the conversation. Then student is directed to speak his/her thoughts, such as to introduce himself/herself, to talk about her/his experience etc. As the student speaks, the instructor types down what the student said in Column A. After the student finishes one thought, the instructor corrects what is in Column A, and places the correct sentence in Column B, using for example parenthesis to remove the incorrect words/phrases, and capital letters to insert what is missing. The student then further identifies the unfamiliar words as new words and places them in Column C. The student may be directed to read out loud the correct sentence in Column B, and the instructor records down the mispronounced words in Column D. After the conversation, a first English lesson is generated. The student is required to make sentences using new words in Column C as homework, and writes them out in Column A on a second, new instruction sheet.

In the next lesson, the instructor corrects the homework the same way as in the first lesson, and writes the corrected sentences into Column B of the second sheet. The instructor also asks the student to read out loud the sentences and writes out the mispronounced words in Column D. If the word was not pronounced correctly, the word continues to be transferred to the next lesson until it is pronounced correctly. The same with the words for which the sentences were not written. If the missing words are new words, the new words are placed into Column C. If the new words exceed 50-60 words, the student and the instructor do the homework together.

In addition, in generating a learning lessons, student may read material based on his/her interests, the as he/she is reading, the instructor is typing the mispronounced words in Column D. The instructor asks and later places the unfamiliar words in Column C. The instructor can explain and type the meaning of the words in Column C.

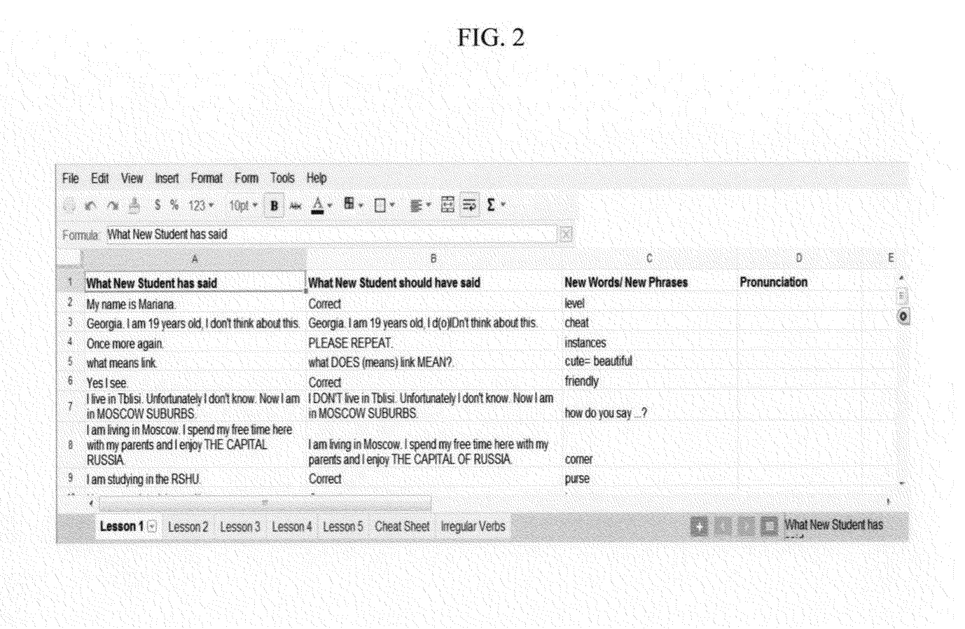

In reference to FIGS. 2-4, the lessons can be generated remotely using the internet and an interface such as the Google™ docs, the spreadsheet program, where the spreadsheet can be shared and viewed simultaneously by the student and the instructor. Each lesson may be placed on one individual sheet. Communications between the learner and the instructor may be through a phone line, a chat program, or an IP talk program.

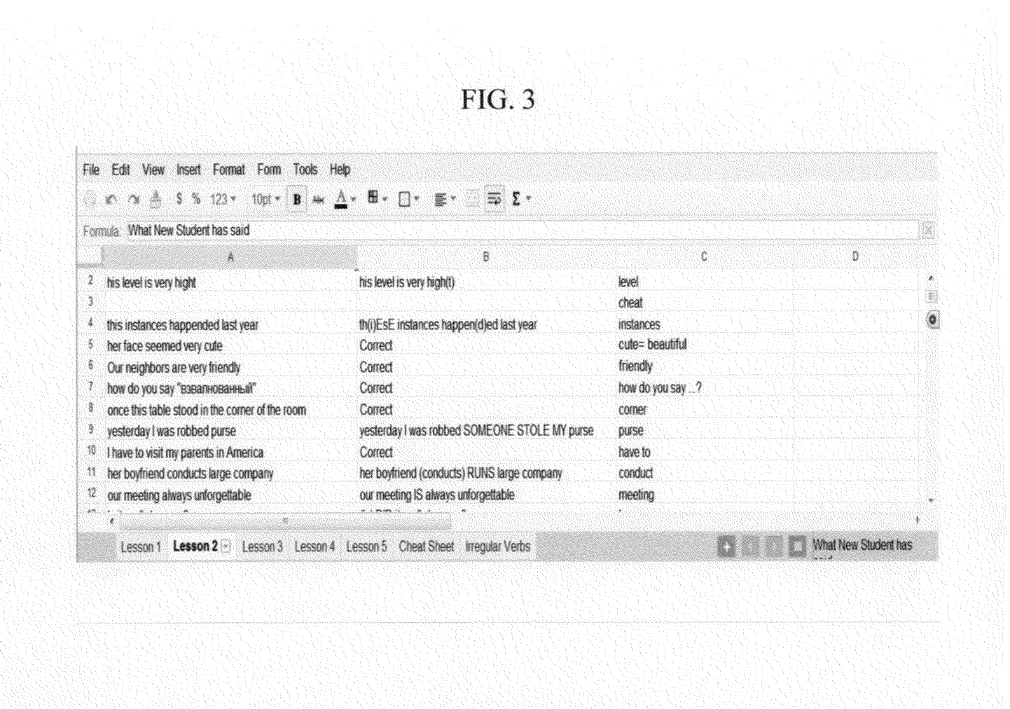

In FIG. 2, lesson 1 produces new words in Column C. The new words in Column C are used to create new sentences by the student in Column A of lesson 2 as shown in FIG. 3 as a homework. The new sentences are corrected in Column B of lesson 2 during lesson 2, and new unfamiliar words are placed in Column C of lesson 3.

Sometimes the capital letters are found in Column A if the student did not know how to say the word and asked to say it “how do you say . . . ” by using a native language, such as a Russian word.

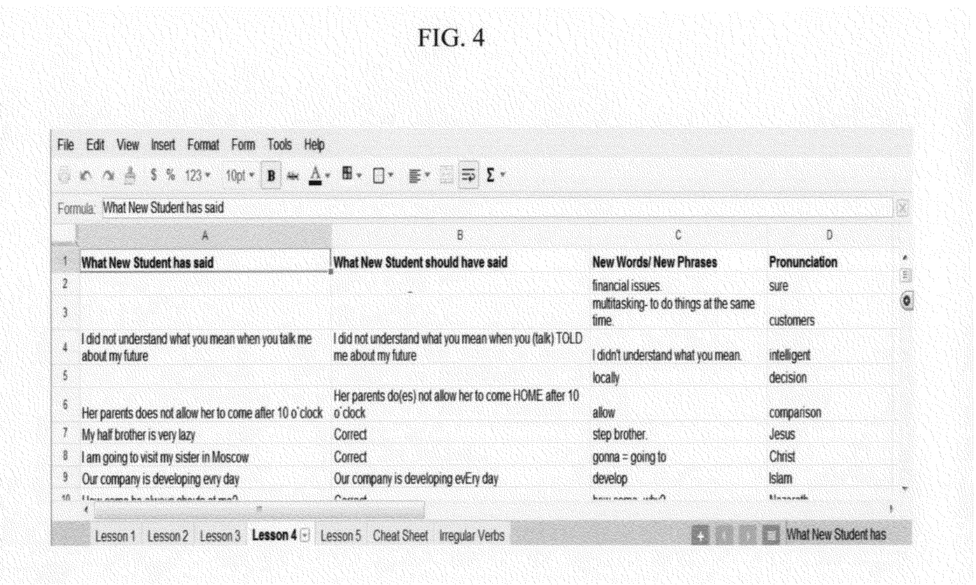

FIG. 4 shows the lesson 4 can generate a complete set of different new words in Column C than in lesson 1. The instructor puts the mispronounced words in Column D which are continued to be transferred to next lesson until they are pronounced correctly.

Lessons generated may be saved for later review, by both the instructor and the student, to solidify or test what the student has learned.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method for generating lessons for learning a foreign language for a learner by an instructor, comprising the actions of:
instructing said learner to speak out loud a spoken sentence in the foreign language;
typing down a written sentence corresponding to the spoken sentence in the foreign language in a first column on a first lesson sheet;
after the sentence is finished spoken and typing,
writing down a correct sentence corresponding to the written sentence using plurality of symbols marking out a correction in a second column in parallel to the first column, on the first lesson sheet;
allowing the learner to identify unfamiliar words from the correct sentence and writing the unfamiliar words to a third column on the first lesson sheet;
placing mispronounced words into a fourth column on the first lesson sheet;
copying said unfamiliar words in the third column to a first column on a second lesson sheet;
copying mispronounced words in the fourth column to a fourth column on the second lesson sheet;
instructing the learner to speak out loud a second spoken sentence in the foreign language using an unfamiliar word in a first column on the second lesson sheet; and
typing down a second written sentence in the foreign language corresponding to said second spoken sentence in the first column on the second lesson sheet.

2. The method of claim 1, wherein the spoken sentence is selected from a reading material of interests to the learner.

3. The method of claim 1, further comprising the action of repeating at least one of the prior actions.

4. The method of claim 1, wherein said first or second lesson sheet is a digital sheet on a computer.

5. The method of claim 1, wherein said first or second lesson sheet is shared simultaneously through internet between the learner and the instructor.

6. The method of claim 1, wherein said first or second lesson sheet is produced by Google™ Docs Program on a central server in a network.

7. The method of claim 1, further comprising the action of transferring the mispronounced word to next lesson until it is correctly pronounced.

8. The method of claim 1, wherein said plurality of symbols includes parenthesis for incorrect word, and capital letters for missing word.

9. The method of claim 1, wherein the learner is allowed to speak out a word in its native language by asking the instructor for the corresponding word in the foreign language.
